(19) United States
(12) Patent Application Publication
(10) Pub. No.: US 2015/0190846 A1
(43) Pub. Date: Jul. 9, 2015

(54) SAND STRAINING TOOL

(71) Applicant: Melissa L. Heim, Crofton, MD (US)

(72) Inventor: Melissa L. Heim, Crofton, MD (US)

(21) Appl. No.: 14/590,113

(22) Filed: Jan. 6, 2015

Related U.S. Application Data
(60) Provisional application No. 61/924,403, filed on Jan. 7, 2014.

(51) Int. Cl. B07B 1/02; A01B 1/02

(52) U.S. Cl. CPC B07B 1/02; A01B 1/02

(57) ABSTRACT

The invention is directed to a sand straining tool. The tool is intended for use in sifting through sand to collect objects. An elongated cylindrical shaft terminates at the upper end in a T-shaped handle. The lower end of the shaft includes a bowl-shaped, porous sifter at the center of a small shovel blade, attached to the shaft at an oblique angle. The angle of the shovel blade allows the user to scoop up sand easily with substantial mechanical advantage, and the T-shaped handle allows the user to agitate the shovel blade so that the sand and any objects it contains will descend into the sifter, with the sand escaping through the holes in the sifter. The design is lightweight, and intended for use on the beach as well as in shallow water.

This application claims the benefit of U.S. provisional application No. 61/924,403 filed Jan. 7, 2014.

### BACKGROUND OF THE INVENTION

The invention relates generally to beach and shoreline tools and accessories, and in particular to a sand straining tool. The hobby of beachcombing has become fairly popular. Seashells, shark's teeth, and other natural items, as well as coins and other items lost by other visitors to the beach, can be easily recovered. Unfortunately, this hobby has generally involved the use of tools intended for other purposes being pressed into service. There is a demand for a specialized tool for beachcombing purposes. A sand straining tool, specifically designed to be used by beachcombers, would satisfy this demand.

### SUMMARY OF THE INVENTION

Accordingly, the invention is directed to a sand straining tool. The tool is intended for use in sifting through sand to collect objects. An elongated cylindrical shaft terminates at the upper end in a T-shaped handle. A small shovel blade is connected with the lower end of the shaft. A concave porous sifter is arranged in the center of t he blade which is preferably attached to the shaft at an oblique angle. The angle of the shovel blade allows the user to scoop up sand easily with substantial mechanical advantage, and the T-shaped handle allows the user to agitate the shovel blade so that the sand and any objects it contains will descend into the sifter, with the sand escaping through the holes in the sifter. The design is lightweight, and intended for use on the beach as well as in shallow water.

### BRIEF DESCRIPTION OF THE FIGURES

Other objects and advantages of the invention will become apparent form a study of the following specification when viewed in the light of the accompanying drawing, in which:

FIG. 1 is a front plan view of a first exemplary embodiment of the sand straining tool according to the invention; and

FIG. 2 is a side view of the tool shown in FIG. 1.

### DETAILED DESCRIPTION

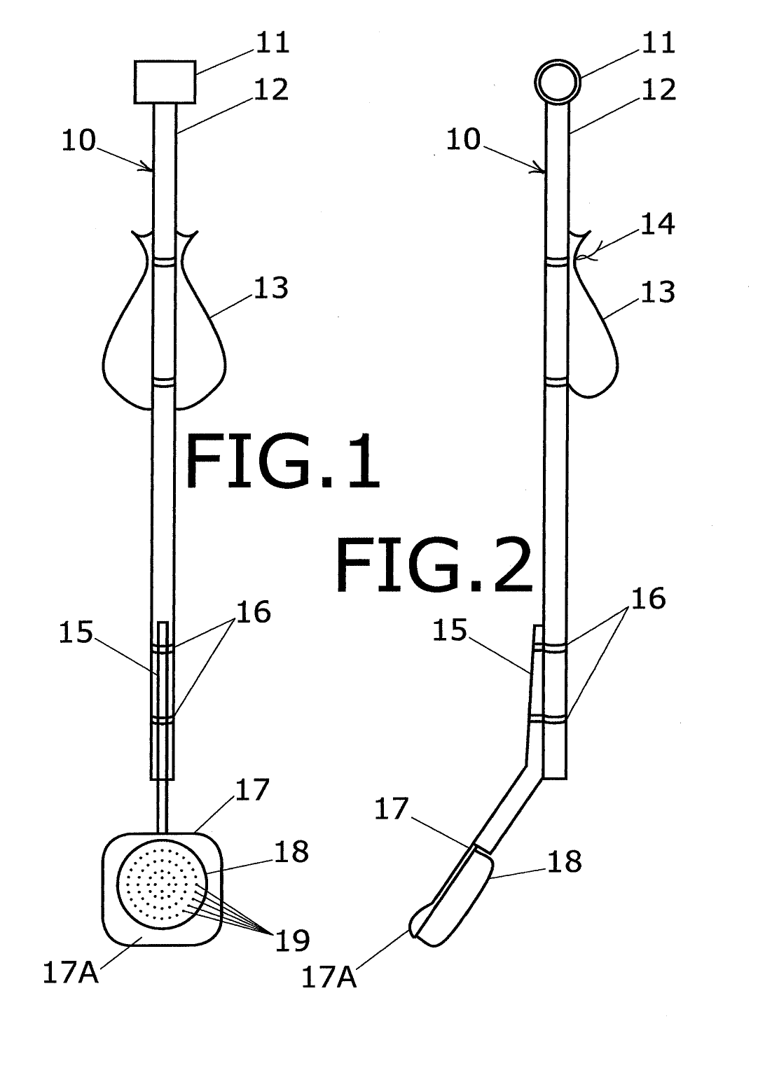

Referring now to FIGS. 1 and 2, the sand straining tool 10 will be described. The tool 10 is intended for use in sifting through sand to collect objects. The tool includes an elongated cylindrical shaft 12. A T-shaped handle 11 is connected with the upper end of the shaft and a small shovel blade 17 is connected with the lower end of the shaft. The central region of the blade contains a concave bowl-shaped porous sifter 18. The shovel blade is preferably attached to the shaft 12 at an oblique angle which allows the user to scoop up sand easily with substantial mechanical advantage. The T-shaped handle 11 allows the user to agitate the shovel blade 17 so that the sand and any objects it contains will descend into the sifter 18, with the sand escaping through holes 19 in the sifter 18. The tool is formed of a lightweight material and is intended for use on the beach as well as in shallow water.

The first exemplary embodiment is provided in one size, but is sufficiently lightweight to be easily handled by women and children. The device features a shaft 12, which is preferably cylindrical, hollow, three feet long and three-quarters inch in diameter. The shaft 12 may be manufactured inexpensively from synthetic plastic pipe or bamboo. The shaft 12 terminates at the upper end in a T-shaped handle 11, the portions of which are preferably cylindrical, two to three inches wide, and one inch in diameter. The T-shaped handle 11 is preferably ergonomically contoured with four grooves for receiving the user's fingers.

A collection bag 13 is connected with the shaft 12, several inches below the T-shaped handle 11. The collection bag 13 is flexible and preferably manufactured from a heavy gauge transparent plastic sheet material. In an alternate embodiment, the collection bag 13 is manufactured from a fine nylon mesh. The collection bag 13 is preferably no more than six inches wide and seven inches long and includes a closure such as a drawstring 14. The bag is preferably secured at both its upper and lower ends to the shaft 12 to prevent any awkward dangling of the bag 13.

The shovel blade 17 is preferably nine inches square, terminating in a lip 17A with rounded corners to prevent injury to the user or damage to the trunk, flooring, or upholstery of the user's vehicle during transport and storage. The rounded corners of the lip 17A are contoured such that they may be employed by the user as smaller shovel blades, to turn over and agitate sand and other material, and scoop individual items out of the sand. The sifter 18 is preferably 6.5 inches in diameter, 2.5 inches deep, and located at the center of the shovel blade 17. According to a preferred embodiment, the holes located in the center of the bottom surface of the sifter 18 have a larger diameter, preferably seven-thirty-seconds inch, than the other holes which are preferably seven-sixty-fourths inch in diameter and distributed throughout the remaining exterior surfaces of the sifter 18. The larger diameter holes concentrated in the center of the sifter 18 are limited in number, such that small, desirable items are recovered easily rather than being flushed through the sifter 18.

The shovel blade 17 and sifter 18 are mounted at the lower end of the shaft 12 at a 30° angle, via a neck portion 15 and binding straps 16. This angle enables the user to reverse the tool 10 and use it in a raking motion through sand or beach debris. The shovel blade 17 and neck 15 may be manufactured inexpensively from sheet metal. In a preferred embodiment, the blade contains a central opening for receiving the sifter 18. The sifters affixed to the shovel blade 17 by pressing, welding, or riveting the parts together.

To use the first exemplary embodiment of the tool 10, the user grips the T-shaped handle 11 with one hand, and the shaft 12 with the other hand. The user may invert the tool and use it in a raking motion through sand or beach debris. If a desirable object is spotted, the user returns the tool 10 to the upright position, scoops up the object and some sand with the shovel blade 17, and agitates the tool 10 such that the object and the sand descend into the sifter 18. The user continues agitating the tool 10 until all the sand passes out of the holes 18, leaving the desirable object in the sifter 18. The user may then remove the desirable object from the sifter 18, place it in the collection bag 13, close the drawstring 14, and continue using the tool 10.

The T-shaped handle 11 is preferably manufactured from a rigid, durable material which is corrosion resistant, shatterproof, and easily cleaned, such as high-impact plastic, wood, or acrylic polymer. The shaft 12 is preferably cylindrical and hollow, and is preferably manufactured from a rigid, durable, lightweight material such as synthetic plastic pipe or bamboo. The collection bag 13 is preferably manufactured from a flexible, durable, transparent material such as heavy gauge transparent plastic sheet. The neck 15, shovel blade 17, and sifter 18 are preferably manufactured from rigid, durable materials such as steel or aluminum alloy. The binding straps 16 are preferably manufactured from a flexible, durable material such as flexible steel.

Components, component sizes, and materials listed above are preferred, but artisans will recognize that alternate components and materials could be selected without altering the scope of the invention.

While the preferred forms and embodiments of the invention have been illustrated and described, it will be apparent to those of ordinary skill in the art that various changes and modifications may be made without deviating from the inventive concepts set forth above.

What is claimed is:

1. A sand straining tool, comprising
(a) an elongated shaft;
(b) a blade connected with one end of said shaft for digging through sand; and
(c) a sifter connected with a center portion of said blade for sifting sand from said blade to reveal objects within the sand as dug by said blade.

2. A sand straining tool as defined in claim 1, and further comprising a handle connected with another end of said shaft to assist with digging and manipulation of said blade.

3. A sand straining tool as defined in claim 2, wherein said blade is arranged at an angle relative to said shaft to provide more efficient digging of said blade.

4. A sand straining tool as defined in claim 3, wherein said sifter contains a plurality of openings.

5. A sand straining tool as defined in claim 4, wherein said openings comprise at least two groups of openings, said groups of openings having different diameters.

6. A sand straining tool as defined in claim 5, wherein said group of openings having a larger diameter are arranged in a central region of said sifter.

7. A sand straining tool as defined in claim 1, wherein said sifter has a concave configuration.

8. A sand straining tool as defined in claim 1, wherein said blade includes a lip extending from a lower edge thereof.

9. A sand straining tool as defined in claim 8, wherein said lip includes rounded corners.

10. A sand straining tool as defined in claim 1, and further comprising a collection bag connected with said shaft intermediate the ends thereof.

11. A sand straining tool as defined in claim 10, wherein said collection bag includes a closure for closing an opening of said bag.
